(19) United States
(12) Patent Application Publication
(10) Pub. No.: US 2026/0252881 A1
(43) Pub. Date: Aug. 27, 2026

(54) DIRECT ERROR-FREE TRAINING METHOD FOR ARTIFICIAL NEURAL NETWORKS

(71) Applicant: Bo Deng, Lincoln, NE (US)

(72) Inventor: Bo Deng, Lincoln, NE (US)

(21) Appl. No.: 19/548,693

(22) Filed: Feb. 24, 2026

Related U.S. Application Data
(60) Provisional application No. 63/764,301, filed on Feb. 27, 2025.

(51) Int. Cl. G06N 3/08

(52) U.S. Cl. CPC G06N 3/08

(57) ABSTRACT

Systems, methods, and computer-readable media are provided for training a neural network using an iterative data-driven methodology that progressively increases a portion of training data satisfying a predefined error criterion. Training data are evaluated to identify data elements that are ε-trained, and a recomposed training subset is formed by combining the ε-trained data with a selected subset of non-ε-trained data. The neural network is trained using the recomposed training subset, after which ε-training status is reevaluated. This process is iteratively repeated until the entire training data set satisfies the ε-training condition. The disclosed approach promotes monotonic expansion of ε-trained data, preserves previously achieved training progress, and enables arbitrarily low training error on a finite training set without requiring predetermined training schedules, specialized initialization, or artificial data sets.

### PRIORITY

The present application claims the benefit under 35 U.S.C. § 119(e) of U.S. Provisional App. No. 63/764,301 (filed Feb. 27, 2025), which is incorporated herein by reference.

### FIELD OF THE INVENTION

Embodiments of the inventive concepts disclosed herein are directed generally toward neural networks, and more particularly toward training methods for neural networks.

### BACKGROUND

Neural networks are widely used for classification, regression, and other machine-learning tasks, and are commonly trained by iteratively adjusting model parameters using training data. In a typical supervised-learning setting, a training set includes a plurality of input samples and corresponding ground-truth outputs, and a neural network model is trained so that predicted outputs match the ground-truth outputs according to a loss function. Conventional training approaches generally update weights and biases using variants of gradient descent, such as stochastic gradient descent, mini-batch training, and training with momentum or adaptive learning rates. These approaches are often effective to achieve useful performance, but in practice they commonly converge to parameter values corresponding to a nonzero residual training error, particularly for finite training sets, due in part to local minima, saddle points, plateaus, and other features of complex optimization landscapes.

In many applications, it is desirable for a neural network to achieve essentially error-free performance with respect to the training data, for example to support subsequent generalization analyses, to enable deterministic behavior on known inputs, or to satisfy operational requirements in domains where misclassification of known cases is unacceptable. However, conventional training protocols frequently require substantial model capacity, careful hyperparameter tuning, specialized initialization, curriculum schedules, or extensive training time to reduce training error, and even then may exhibit accuracy oscillations or regressions during training. Moreover, training procedures may stall at intermediate performance levels, resulting in persistent misclassified training samples and requiring repeated manual interventions such as rebalancing data, modifying learning-rate schedules, or restarting training from different initializations.

In some embodiments, evaluation of training data elements may be performed using outputs produced by the neural network prior to any parameter updates, such as when the neural network is untrained or initialized to default parameter values. In other embodiments, evaluation may be performed during or after one or more training iterations.

In some embodiments, the predefined ε-training condition may be selected based on characteristics of the training data set, including separations between training data elements in an output space or feature space, such that training data elements satisfying the ε-training condition may be regarded as fully trained with respect to the training data set. Selection of E based on such characteristics is optional and is not required for operation of the disclosed training methodology.

In some embodiments, progress of training may be monitored using a metric representing a portion or proportion of training data elements that satisfy the ε-training condition during a given iteration. Such monitoring may be used to assess training progression or completion, although the disclosed training methodology does not require use of a specific numeric rate, threshold, or stopping rule.

In some embodiments, training of the neural network using the recomposed training subset may be performed using gradient-based optimization techniques, including gradient descent with or without momentum, or other parameter-adjustment algorithms. The disclosed training methodology is not limited to any particular optimization technique.

In some embodiments, parameters obtained using the disclosed training methodology may be provided as input to a subsequent training, fine-tuning, or optimization process. Such subsequent processing is optional and is not required for operation of the disclosed training methodology.

Accordingly, there remains a need for improved neural network training techniques that more reliably drive training error toward an arbitrarily low threshold on a finite training set, without requiring special initialization strategies, predetermined syllabi or curricula, or predetermined training lengths, and that can increase the number of correctly trained data elements in a stable manner during training.

### SUMMARY

In accordance with one or more embodiments, the present disclosure is directed to systems, methods, and computer-readable media for training a neural network in a manner that progressively and reliably increases the number of training data elements that satisfy a predefined error criterion. Rather than relying on fixed training schedules or undifferentiated batch selection, the disclosed techniques operate by dynamically identifying data elements that are already trained to within a specified tolerance and selectively combining those data elements with additional, not-yet-trained data to form recomposed training subsets used in subsequent training iterations.

In one embodiment, a neural network is initialized and evaluated with respect to a training data set to determine which data elements satisfy an ε-training condition, indicating that the network output for those elements differs from corresponding ground-truth outputs by no more than a predefined threshold. The training data set is partitioned into an ε-trained subset and a complementary subset of non-ε-trained data. A stocking subset is then selected from the non-ε-trained data and combined with the ε-trained subset to form a recomposed training subset. The neural network is trained using the recomposed training subset, after which the ε-training status of the training data is reevaluated.

This process is iteratively repeated, with each iteration tending to increase the number of data elements that satisfy the ε-training condition. In exemplary embodiments, once a data element becomes ε-trained, it remains ε-trained in subsequent iterations, such that the portion of ε-trained data increases monotonically until the entire training data set satisfies the ε-training condition. Training may terminate when all training data elements are ε-trained, resulting in a neural network that exhibits arbitrarily low training error with respect to the training data set.

The disclosed techniques may be implemented in a computer apparatus comprising one or more processors and memory storing executable instructions that perform the described training operations, including evaluating ε-training status, selecting stocking subsets, forming recomposed training subsets, and controlling iterative training. The methods are applicable to a wide variety of neural network architectures and training algorithms, and may be used to improve training stability, reduce accuracy oscillations, and eliminate persistent misclassification of training data without requiring specialized initialization schemes or predetermined training curricula.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram illustrating a computer apparatus configured to train a neural network using an iterative training methodology, according to an exemplary embodiment.

FIG. 2 shows a data-centric functional diagram illustrating partitioning of an original training data set into an ε-trained data subset and a non-ε-trained data subset, selection of a stocking subset, and formation of a recomposed training subset, according to an exemplary embodiment.

FIG. 3 shows a flowchart illustrating a method for training a neural network by iteratively evaluating ε-training status, forming recomposed training subsets, and training the neural network until the training data set satisfies an ε-training condition, according to an exemplary embodiment.

FIG. 4 shows a graphical representation illustrating an exemplary monotonic increase in a portion of ε-trained data over successive training iterations during execution of the disclosed training method, according to an exemplary embodiment.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to systems, methods, and computer-readable media for training a neural network using an iterative data-driven methodology that progressively increases a portion of training data satisfying a predefined error criterion. Training data are evaluated to identify data elements that are ε-trained, and a recomposed training subset is formed by combining the ε-trained data with a selected subset of non-ε-trained data. The neural network is trained using the recomposed training subset, after which ε-training status is reevaluated. This process is iteratively repeated until the entire training data set satisfies the ε-training condition. The disclosed approach promotes monotonic expansion of ε-trained data, preserves previously achieved training progress, and enables arbitrarily low training error on a finite training set without requiring predetermined training schedules, specialized initialization, or artificial data sets.

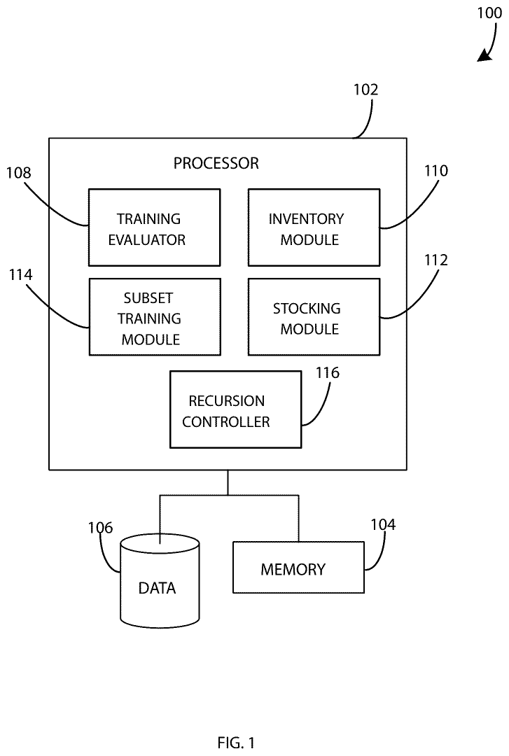

Referring now to FIG. 1, a block diagram is shown illustrating a computer apparatus 100 configured to train a neural network using an iterative ε-training methodology, according to an exemplary embodiment of the present disclosure. The computer apparatus 100 may be implemented using any suitable computing platform, including a general-purpose computer, a workstation, a server, a cloud-based computing system, or a specialized computing device, and may be implemented using hardware, software, firmware, or any combination thereof.

The computer apparatus 100 includes at least one processor 102 in data communication with a memory 104 and a data storage element 106. The processor 102 may comprise one or more processing cores and may be configured to execute program instructions stored in memory 104. The memory 104 may include any suitable non-transitory computer-readable medium, such as volatile memory, non-volatile memory, or a combination thereof, for storing executable instructions and intermediate computational results. The data storage element 106 may store one or more training data sets, subsets thereof, model parameters, or other data used during neural network training.

In the illustrated embodiment, the processor 102 executes a plurality of functional modules that collectively implement an iterative training controller for training a neural network. These modules are shown as logical components for clarity of explanation and are not intended to imply separate hardware units unless expressly stated. In particular, the processor 102 is configured to execute a training evaluator 108, an inventory module 110, a stocking module 112, a subset training module 114, and a recursion controller 116. The functional modules illustrated in FIG. 1 represent logical components that may be implemented using software, firmware, hardware logic, or any combination thereof. The illustrated separation of functionality is for explanatory purposes and does not require discrete implementation of the modules as separate program units or hardware elements.

The training evaluator 108 is configured to evaluate the output of a neural network with respect to training data stored in the data storage element 106. In some embodiments, the training evaluator 108 evaluates outputs produced by the neural network prior to any training or parameter updates, such as when the neural network is untrained or initialized to default parameter values. In other embodiments, evaluation may be performed during or after one or more training iterations. In one embodiment, the training evaluator 108 determines, for individual data elements of a training data set, whether the neural network output satisfies a predefined ε-training condition, such as whether an error metric associated with a data element is less than or equal to a specified threshold. The ε-training condition may be defined using any suitable loss function or distance metric, and the present disclosure is not limited to any particular choice of loss function. In some embodiments, the ε-training condition evaluated by the training evaluator 108 may be selected based on characteristics of the training data set, including separations between training data elements in an output or feature space, such that data elements satisfying the ε-training condition may be regarded as fully trained with respect to the training data set.

The inventory module 110 is configured to identify and maintain an ε-trained data subset comprising those training data elements determined by the training evaluator 108 to satisfy the ε-training condition. In exemplary embodiments, the inventory module 110 records membership of data elements in the ε-trained subset and updates that membership across training iterations. Once a data element is identified as ε-trained, it may be retained in the ε-trained subset during subsequent iterations, thereby preserving training progress across iterations. In exemplary embodiments, once a training data element is identified as ε-trained, the inventory module 110 maintains the data element in the ε-trained data subset during subsequent training iterations, such that previously achieved training status is preserved and not degraded by later training.

The stocking module 112 is configured to select a stocking subset from training data elements that are not currently included in the ε-trained data subset. In one embodiment, the stocking subset is selected from the complement of the ε-trained data, for example by random selection, pseudo-random selection, or selection according to one or more criteria. The stocking subset may have a size related to, but not necessarily equal to, the size of the ε-trained subset. The stocking module 112 enables controlled introduction of additional, not-yet-trained data into subsequent training iterations. In some embodiments, a size of the stocking subset selected by the stocking module 112 may be a function of a size of the ε-trained data subset or to a number of training data elements that do not satisfy the ε-training condition.

The subset training module 114 is configured to train the neural network using a recomposed training subset formed from the ε-trained data subset identified by the inventory module 110 and the stocking subset selected by the stocking module 112. Training performed by the subset training module 114 may utilize any suitable training algorithm, including gradient-based or other parameter-adjustment techniques, and is intentionally abstracted from the particular optimization method employed. The subset training module 114 updates neural network parameters stored in memory 104 based on the recomposed training subset.

The recursion controller 116 is configured to control iterative execution of the training process. In particular, the recursion controller 116 determines whether the entire training data set satisfies the ε-training condition, based on evaluations performed by the training evaluator 108 and inventory module 110. If the training data set is not yet fully ε-trained, the recursion controller 116 initiates another iteration of subset selection and training. If all training data elements satisfy the ε-training condition, the recursion controller 116 may terminate training and output a trained neural network model. In some embodiments, the recursion controller 116 may monitor a metric representing a portion or proportion of training data elements that satisfy the ε-training condition in order to assess training progress or completion. Such monitoring is optional and does not require use of a specific numeric rate, threshold, or stopping rule.

In operation, the computer apparatus 100 of FIG. 1 enables training of a neural network in which the set of ε-trained data elements tends to increase across iterations. Unlike conventional training approaches that operate on fixed batches or epochs without regard to training status of individual data elements, the apparatus 100 dynamically recomposes training subsets based on ε-training status, thereby promoting stable and progressive training behavior. In some embodiments, parameters obtained using the training process illustrated in FIG. 1 may be provided as input to a subsequent training, fine-tuning, or optimization process. Such subsequent processing is optional and is not required for operation of the illustrated training architecture.

It will be appreciated that FIG. 1 illustrates one exemplary system architecture, and that variations and modifications may be made without departing from the scope of the disclosure. For example, the functional modules illustrated in FIG. 1 may be combined, subdivided, or distributed across multiple processors or computing devices, and the disclosed architecture may be applied to a wide variety of neural network models and training environments.

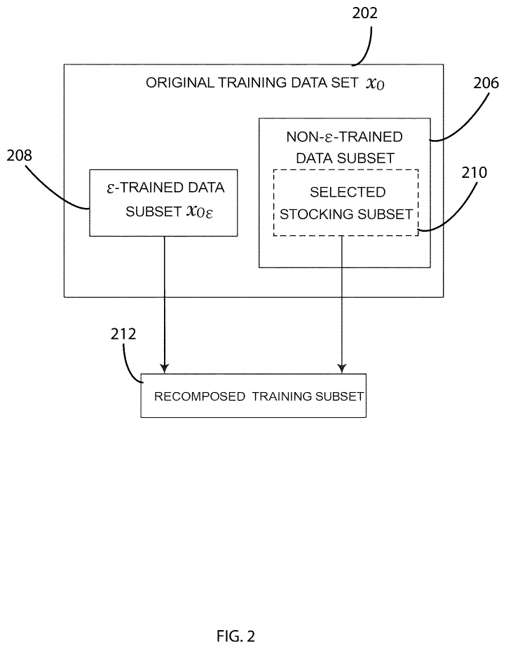

Referring now to FIG. 2, a data-centric functional architecture is illustrated showing how a training data set is partitioned and recomposed during iterative training of a neural network, according to an exemplary embodiment of the present disclosure. FIG. 2 is intended to illustrate relationships among data sets and subsets used during training, rather than a temporal execution sequence.

As shown in FIG. 2, an original training data set 202 (denoted conceptually as x₀) comprises a plurality of training data elements, each associated with corresponding ground-truth outputs. The original training data set 202 may include data of any suitable type, including but not limited to numerical data, images, audio signals, text, or other structured or unstructured data.

The original training data set 202 is conceptually partitioned into two complementary subsets based on an ε-training condition evaluated with respect to a neural network model. A first subset is an ε-trained data subset 208 (denoted conceptually as x_{0ε}), which includes training data elements for which the neural network output satisfies a predefined ε-training criterion. The ε-training criterion may be defined using any suitable error metric or loss function and may indicate, for example, that the neural network output differs from the corresponding ground-truth output by no more than a specified tolerance. In some embodiments, the ε-training condition used to partition the training data set may be selected based on characteristics of the training data set, including separations between training data elements in an output space or feature space, such that training data elements satisfying the ε-training condition may be regarded as fully trained with respect to the training data set. The partitioning illustrated in FIG. 2 does not require that the ε-trained data subset be non-empty and, in some embodiments, the ε-trained data subset may initially be empty, such as when the neural network is untrained or minimally initialized.

A second subset is a non-ε-trained data subset 206 (denoted conceptually as x̅_{0ε}), which includes training data elements that do not satisfy the ε-training criterion at a given point during training. In the illustrated embodiment, the ε-trained data subset 208 and the non-ε-trained data subset 206 together form a complete partition of the original training data set 202.

In some embodiments, from the non-ε-trained data subset 206, a selected stocking subset 210 is identified. The selected stocking subset 210 comprises a proper subset of the non-ε-trained data and may be selected using random selection, pseudo-random selection, or selection based on one or more criteria. The selected stocking subset 210 is illustrated using a dashed outline to indicate that it represents a selection operation rather than a fixed or exhaustive subset. The size of the selected stocking subset 210 may be related to the size of the ε-trained data subset 208, although such a relationship is not required. In some embodiments, selection of the stocking subset may be influenced by a size of the ε-trained data subset or by a number of training data elements that do not satisfy the ε-training condition, although no particular relationship, ratio, or numeric constraint is required.

In some embodiments, the stocking subset is selected from the original training data set 202 rather than exclusively from the non-ε-trained data subset. In such embodiments, the stocking subset may be selected randomly or pseudo-randomly from the entire training data set, and may have a cardinality equal to that of the ε-trained data subset. Because selection is performed from the entire training data set, the stocking subset may include data elements that are already included in the ε-trained data subset, and overlap between the two subsets is permitted. Selection from the entire training data set ensures that a stocking subset of desired size may always be formed, including in later iterations when the non-ε-trained subset becomes small.

A recomposed training subset 212 is formed by combining the ε-trained data subset 208 with the selected stocking subset 210. Conceptually, the recomposed training subset 212 may be regarded as a union of the ε-trained data subset and the selected stocking subset 210. The recomposed training subset 212 is used as the training data for a subsequent training iteration of the neural network. By including the ε-trained data subset in the recomposed training subset, training progress achieved in earlier iterations may be preserved, such that training data elements that have become ε-trained are not degraded by subsequent training iterations.

By including the ε-trained data subset 208 in the recomposed training subset 212, training progress achieved in prior iterations may be preserved, while inclusion of the selected stocking subset 210 introduces additional, previously non-ε-trained data elements into the training process. After training using the recomposed training subset 212, ε-training status of the training data may be reevaluated, and membership of data elements in the ε-trained data subset 208 and non-ε-trained data subset 206 may be updated accordingly.

In exemplary embodiments, this process is iteratively repeated such that the ε-trained data subset 208 tends to increase across iterations, while the non-ε-trained data subset 206 correspondingly decreases. Once a data element becomes ε-trained, it may remain in the ε-trained data subset in subsequent iterations, thereby promoting monotonic expansion of the ε-trained portion of the training data set.

FIG. 2 differs from conventional mini-batch or epoch-based training schemes in that selection of training data for subsequent iterations is explicitly conditioned on ε-training status of individual data elements, rather than being determined solely by fixed batch sizes or iteration counts. Additionally, FIG. 2 does not depict creation of artificial or averaged data sets, nor does it rely on continuation or homotopy between different data sets, thereby distinguishing the illustrated approach from other neural network training techniques disclosed by the same inventor.

It will be appreciated that the data-centric relationships illustrated in FIG. 2 are exemplary and that variations and modifications may be made without departing from the scope of the disclosure. For example, selection criteria for the stocking subset, definitions of the ε-training condition, and relative sizes of the illustrated subsets may be adapted for different neural network architectures, training objectives, or application domains. In some embodiments, progress of training may be assessed using a metric representing a portion or proportion of training data elements included in the ε-trained data subset, although the illustrated data relationships do not require use of a particular numeric metric or stopping criterion.

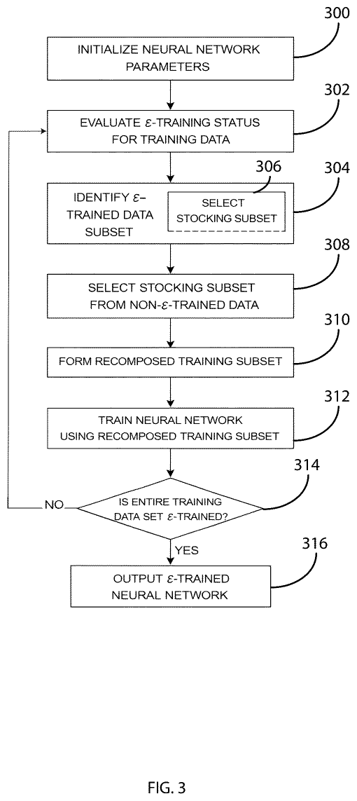

Referring now to FIG. 3, a flowchart is shown illustrating a method for training a neural network using an iterative ε-training process, according to an exemplary embodiment of the present disclosure. FIG. 3 depicts a logical sequence of operations performed by a computer apparatus, such as the system illustrated in FIG. 1, and is not intended to imply a particular hardware configuration or a specific training algorithm unless expressly stated.

Neural network parameters are initialized 300. The parameters may include weights, biases, or other adjustable values associated with a neural network model. In exemplary embodiments, initialization may include setting one or more parameters to zero, random values, or other suitable initial values. The present disclosure does not require a particular initialization strategy, and initialization may be selected according to implementation preferences or application requirements.

The ε-training status is evaluated 302 for training data elements. In some embodiments, evaluation is performed prior to any parameter updates, such as when the neural network is untrained or minimally initialized, in order to determine an initial ε-training status of the training data elements. Outputs produced by the neural network for training data elements are compared with corresponding ground-truth outputs using one or more error metrics or loss functions. A data element may be determined to satisfy an ε-training condition if an associated error value is less than or equal to a predefined tolerance. Evaluation of ε-training status may be performed for individual data elements or groups of data elements. In some embodiments, the ε-training condition may be selected based on characteristics of the training data set, including separations between training data elements in an output space or feature space, such that training data elements satisfying the ε-training condition may be regarded as fully trained with respect to the training data set.

An ε-trained data subset is identified 304. The ε-trained data subset includes training data elements determined during evaluation 302 to satisfy the ε-training condition. Identification of the ε-trained data subset may involve recording identifiers, indices, or other references to data elements that meet the ε-training criterion. In some embodiments, the identified ε-trained data subset may initially be empty, such as when the neural network is untrained or minimally initialized.

A stocking subset is selected 306. In some embodiments, the stocking subset is selected randomly or pseudo-randomly from the entire training data set. Alternatively, the stocking subset may be selected from training data elements that are not included in the ε-trained data subset. In exemplary embodiments, the stocking subset may be selected randomly, pseudo-randomly, or according to one or more selection criteria. The stocking subset may include a number of data elements related to, but not necessarily equal to, the number of ε-trained data elements. The stocking subset may have a cardinality equal to that of the ε-trained data subset. In some embodiments, selection of the stocking subset may be influenced by a size of the ε-trained data subset or by a number of training data elements that do not satisfy the ε-training condition, although no particular relationship, ratio, or numeric constraint is required. Because selection may be performed from the entire training data set, the stocking subset may overlap with the ε-trained data subset. Such overlap does not interfere with operation of the method and may result in rapid iteration when a selected stocking subset contains data elements already satisfying the ε-training condition.

The stocking subset is selected 308 from the non-ε-trained data. Selection emphasizes that the stocking subset is drawn from training data elements that do not currently satisfy the ε-training condition, thereby introducing additional, not-yet-trained data into subsequent training iterations.

A recomposed training subset is formed 310. The recomposed training subset includes at least the identified ε-trained data subset and the selected stocking subset. Conceptually, the recomposed training subset may be regarded as a union of the ε-trained data subset and the stocking subset. The recomposed training subset serves as the training data for a subsequent training iteration. By including previously ε-trained data elements in the recomposed training subset, training progress achieved in earlier iterations may be preserved, such that training data elements that have become ε-trained are not degraded by subsequent training iterations.

The neural network is trained 312 using the recomposed training subset. Training may involve updating neural network parameters using any suitable training algorithm, including gradient-based or other parameter-adjustment techniques. Training may be performed using gradient-based optimization techniques, including gradient descent with or without momentum, adaptive learning-rate methods, or other parameter-adjustment algorithms. The present disclosure does not require a specific training algorithm and is compatible with a variety of neural network architectures and training methodologies.

The system executing the process determines 314 whether the entire training data set satisfies the ε-training condition. In some embodiments, determination may involve monitoring a metric representing a portion or proportion of training data elements that satisfy the ε-training condition across iterations in order to assess training progress or completion. Such monitoring does not require use of a specific numeric rate, threshold, or stopping rule. If one or more training data elements do not satisfy the ε-training condition, the method executes another loop beginning where the ε-training status is evaluated 302 again and another iteration is performed. If all training data elements satisfy the ε-training condition, an ε-trained neural network is output 316. The output neural network may be stored, deployed, or further processed as required by a particular application. In some embodiments, the ε-trained neural network output at step 316 may be provided as input to a subsequent training, fine-tuning, or optimization process.

In exemplary embodiments, the iterative process illustrated in FIG. 3 tends to increase the number of ε-trained data elements across successive iterations. Once a data element satisfies the ε-training condition, it may remain ε-trained in subsequent iterations, thereby promoting monotonic expansion of the ε-trained data subset. The method illustrated in FIG. 3 does not rely on predetermined training lengths, predefined curricula, or artificial data sets, and differs from continuation-based or homotopy-based training approaches previously disclosed by the same inventor.

It will be appreciated that FIG. 3 illustrates one exemplary method flow, and that variations, reordering of steps, or optional steps may be implemented without departing from the scope of the disclosure, provided that iterative evaluation of ε-training status and recomposition of training subsets are maintained.

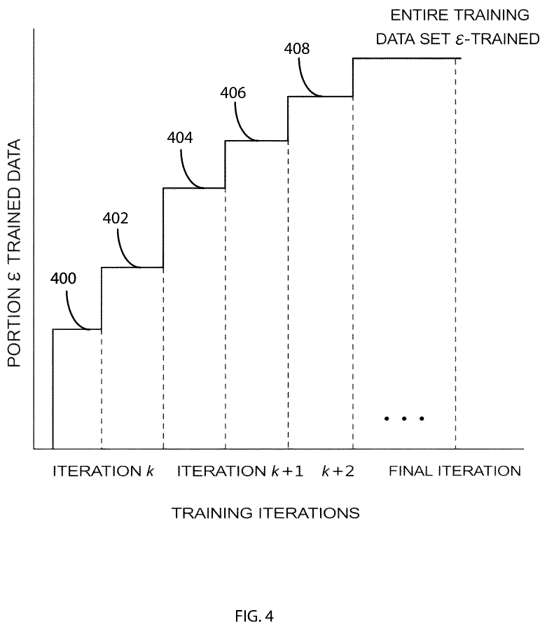

Referring now to FIG. 4, a graphical representation is shown illustrating an exemplary progression of ε-trained data during iterative training of a neural network, according to an embodiment of the present disclosure. FIG. 4 is intended to provide an intuitive visualization of training behavior resulting from the methods described with respect to FIGS. 1-3 and is illustrative rather than quantitative.

In the illustrated embodiment, a horizontal axis represents training iterations, while a vertical axis represents a portion of ε-trained data within an original training data set. The portion of ε-trained data may correspond to, for example, a cardinality or fraction of training data elements that satisfy a predefined ε-training condition at a given point during training. In some embodiments, each increase illustrated in FIG. 4 corresponds to completion of a training iteration performed using a recomposed training subset, after which additional training data elements transition from a non-ε-trained state to an ε-trained state.

The curve illustrated in FIG. 4 exhibits a stepwise, non-decreasing progression, with successive increases corresponding to completion of individual training iterations performed using recomposed training subsets, as described with respect to FIG. 3. Each upward step may represent an iteration in which additional training data elements transition from a non-ε-trained state to an ε-trained state as a result of training on a recomposed training subset. Horizontal portions of the curve illustrate intervals during which one or more training iterations may be performed without immediate expansion of the ε-trained portion of the training data. In at least one embodiments, once a training data element satisfies the ε-training condition, that data element remains ε-trained in subsequent iterations, such that the portion of ε-trained data does not decrease across iterations.

In exemplary embodiments, once a training data element satisfies the ε-training condition, it remains ε-trained in subsequent iterations. Accordingly, the portion of ε-trained data illustrated in FIG. 4 does not decrease across iterations, reflecting preservation of training progress achieved in earlier iterations. This behavior differs from conventional training approaches in which training accuracy for individual data elements may fluctuate or regress during training.

The curve may reach a terminal plateau corresponding to a condition in which the entire training data set is ε-trained. When this condition is reached, iterative training may terminate, and a trained neural network may be output. The final plateau indicates that all training data elements satisfy the ε-training condition, resulting in arbitrarily low training error with respect to the training data set. Such intervals may correspond to iterations in which training is performed without immediate expansion of the ε-trained data subset, for example where additional training is required before further data elements satisfy the ε-training condition.

FIG. 4 illustrates an outcome of the disclosed data-driven training methodology, in which ε-trained data elements are progressively accumulated across iterations through selective recomposition of training subsets. The illustrated monotonic behavior is a consequence of retaining ε-trained data elements during subsequent training iterations rather than restarting or backtracking training.

It will be appreciated that the shape of the curve shown in FIG. 4 is exemplary and that the number of iterations, relative step sizes, and exact progression may vary depending on factors such as training data composition, neural network architecture, ε-training criteria, and training algorithms employed. FIG. 4 is therefore intended to illustrate general qualitative behavior associated with the disclosed training techniques rather than to define specific performance characteristics or guarantees.

In some embodiments, behavior of the disclosed ε-training methodology may be described or analyzed using a mathematical formulation. In an exemplary embodiment, the mathematical basis is described herein.

Let a training data set be denoted as x⁰={x^{0,1}, x^{0,2}, . . . , x^{0,m}}, with corresponding target outputs y⁰=g(x⁰, W, b). For a given training data element x^{0,i} there is a ground truth z^{0,i}, and function of training is to find parameters p such that the output y^{0,i} can be uniquely identified with z^{0,i}. Let L(y, z) be a loss function. For any arbitrarily small ε>0, a model is ε-trained for an input x^{0,i} if L(y^{0,i},z^{0,i})≤ε. A set of data x⁰ is ε-trained if L(y^{0,i}, z^{0,i})≤ε is true for every datum in the set. In this disclosure, ε denotes any small number that is smaller than the mutual losses:

$$0 < ε < min \{ L ( {y}^{0 , i} , {z}^{0 , j} ) : i \neq j \}$$

In some analytical embodiments, ε may be selected relative to a separation between training data elements in an output space or feature space. Under such conditions, satisfaction of the ε-training condition by a training data element implies that the neural network output for that element uniquely corresponds to its correct target output. In such embodiments, training data elements satisfying the ε-training condition may be regarded as fully trained with respect to the training data set. Selection of ε according to such criteria is optional and is not required for operation of the disclosed training methodology.

At a given iteration k, an ε-trained data subset may be defined as

$${x}_{ε , k}^{0} ,$$

and a complementary non-ε-trained subset may be defined as x̅_{εk}^{0,c}. An ε-positive rate r_{ε,k} may be defined as the ration of

$${x}_{ε , k}^{0} / {x}^{0} . If {r}_{ε , k} = 1$$

or stops improving, parameters pₖ={Wₖ, bₖ} are output. Otherwise the process continues.

In at least one embodiment, a recomposed subset sₖ is formed by selecting a subset

$${\overline{x}}_{ε , k}^{0} ,$$

random or otherwise, of the same size as as

$${x}_{ε , k}^{0} ,$$

and performing a union wherein

$${s}_{k} = {\overline{x}}_{ε , k}^{0} ⋃ {x}_{ε , k}^{0} .$$

Alternatively, the subset

$${\overline{x}}_{ε , k}^{0} ,$$

may include one or more elements of ε-trained data. The subset sₖ may then be used to train the model g(sₖ, Wₖ, bₖ) by gradient descent, with or without momentum, to obtain pₖ₊₁={Wₖ₊₁, bₖ₊₁}.

The rate r_{ε,k} may be used to analyze convergence behavior, monotonicity, or termination conditions of the disclosed training methodology. Operation of the disclosed training methodology does not require computation of a particular rate, formula, or recurrence relation.

Under certain analytical assumptions, including appropriate selection of ε and use of suitable parameter-adjustment algorithms, the sequence r_{ε,k} may be non-decreasing across iterations, such that r_{ε,k+1}≥r_{ε,k}. In such analytical interpretations, convergence may be said to occur when r_{ε,k}=1, corresponding to satisfaction of the ε-training condition by all training data elements. These relationships describe analytical properties that may arise in certain embodiments and do not impose requirements or guarantees on execution of the disclosed training methodology.

Certain analytical results may assume that neural network parameters pₖ are updated using gradient-based optimization techniques, such as gradient descent with or without momentum. The disclosed training methodology is not limited to gradient-based optimization and is compatible with a variety of parameter-adjustment techniques.

The mathematical expressions and relationships described in this section are provided to aid understanding of the disclosed training methodology and to illustrate properties that may arise in certain embodiments. Operation of the disclosed training methodology does not require explicit computation of the foregoing expressions, satisfaction of the stated inequalities, or reliance on theoretical guarantees, and the invention is defined by its operational steps and data-handling mechanisms rather than by any particular mathematical formulation.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in at least one embodiment, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A method for training a neural network, comprising:
evaluating, via at least one processor, a training data set to determine which training data elements satisfy a predefined ε-training condition;
identifying an ε-trained data subset comprising training data elements that satisfy the ε-training condition;
selecting a stocking subset from the training data set;
forming a recomposed training subset comprising at least the ε-trained data subset and the stocking subset;
training the neural network using the recomposed training subset; and
iteratively repeating the evaluating, identifying, selecting, forming, and training until the training data set satisfies the ε-training condition.

2. The method of claim 1, wherein the stocking subset has a cardinality equal to a cardinality of the ε-trained data subset.

3. The method of claim 1, wherein the ε-training condition is based on an error metric between neural network outputs and corresponding ground-truth outputs being less than or equal to a predefined threshold.

4. The method of claim 1, wherein the stocking subset is selected randomly or pseudo-randomly from the training data elements that do not satisfy the ε-training condition.

5. The method of claim 1, wherein once a training data element satisfies the ε-training condition, the training data element remains in the ε-trained data subset during subsequent iterations.

6. The method of claim 1, wherein a portion of the training data set that satisfies the ε-training condition increases monotonically across iterations.

7. The method of claim 1, wherein training terminates when all training data elements satisfy the ε-training condition.

8. A system for training a neural network, comprising:
at least one processor; and
a memory in data communication with the at least one processor, storing non-transitory processor executable code that, when executed by the at least one processor, cause the system to:
evaluate a training data set to determine which training data elements satisfy a predefined ε-training condition;
identify an ε-trained data subset comprising training data elements that satisfy the ε-training condition;
select a stocking subset from the training data set;
form a recomposed training subset comprising at least the ε-trained data subset and the stocking subset;
train the neural network using the recomposed training subset; and
iteratively repeat the evaluating, identifying, selecting, forming, and training until the training data set satisfies the ε-training condition.

9. The system of claim 8, wherein the stocking subset is selected randomly from the entire training data set.

10. The system of claim 8, wherein the ε-training condition is based on an error metric between neural network outputs and corresponding ground-truth outputs being less than or equal to a predefined threshold.

11. The system of claim 8, wherein the stocking subset is selected randomly or pseudo-randomly from the training data elements that do not satisfy the ε-training condition.

12. The system of claim 8, wherein the at least one processor is further configured to preserve membership of ε-trained data elements across iterations.

13. The system of claim 8, wherein the at least one processor is further configured to instantiate a recursion controller configured to determine whether iterative training should continue.

14. The system of claim 8, wherein the at least one processor is further configured to dynamically recompute the ε-trained data subset after each training iteration.

15. A computer apparatus for training a neural network, comprising:
a data storage element storing a training data set;
at least one processor in data communication with the data storage element; and
a memory storing non-transitory processor-executable instructions that configure the at least one processor to:
evaluate a training data set to determine which training data elements satisfy a predefined ε-training condition;
identify an ε-trained data subset comprising training data elements that satisfy the ε-training condition;
select a stocking subset from the training data set;
form a recomposed training subset comprising at least the ε-trained data subset and the stocking subset;
train the neural network using the recomposed training subset; and
iteratively repeat the evaluating, identifying, selecting, forming, and training until the training data set satisfies the ε-training condition.

16. The computer apparatus of claim 15, wherein the at least one processor is further configured to initialize neural network parameters prior to evaluating ε-training status.

17. The computer apparatus of claim 15, wherein the recomposed training subset excludes at least a portion of the non-ε-trained data not selected as the stocking subset.

18. The apparatus of claim 15, wherein the stocking subset includes at least one training data element that satisfies the ε-training condition.

19. The apparatus of claim 15, wherein the ε-training condition is based on an error metric between neural network outputs and corresponding ground-truth outputs being less than or equal to a predefined threshold.

20. The apparatus of claim 15, wherein the at least one processor is further configured to preserve membership of ε-trained data elements across iterations.
